(19) United States
(12) Patent Application Publication
(10) Pub. No.: US 2012/0020303 A1
(43) Pub. Date: Jan. 26, 2012

(54) Method and Apparatus for a Dynamic Create/Change of Service Flows

(75) Inventors: Phillip Barber, McKinney, TX (US); Limei Wang, San Diego, CA (US)

(73) Assignee: FutureWei Technologies, Inc., Plano, TX (US)

(21) Appl. No.: 13/253,603

(22) Filed: Oct. 5, 2011

Related U.S. Application Data
(63) Continuation of application No. 12/357,254, filed on Jan. 21, 2009.
(60) Provisional application No. 61/023,028, filed on Jan. 23, 2008.
(60) Provisional application No. 61/022,257, filed on Jan. 18, 2008.

(51) Int. Cl. H04W 8/00

(52) U.S. Cl. 370/328

(57) ABSTRACT

A system and method for transmitting data is provided. A preferred embodiment comprises transmitting data by concatenating parameters for multiple service flows into a single transmission. Parameters associated with multiple service flows may be grouped together and other parameters that are not associated with multiple service flows are also preferably included within the same single transmission.

This application is a continuation of U.S. patent application Ser. No. 12/357,254, filed on Jan. 21, 2009, which claims the benefit of U.S. Provisional Application No. 61/023,028, filed on Jan. 23, 2008, entitled “Method for Dynamic Create/Change a Bundle of Service Flows,” and U.S. Provisional Application No. 61/022,257, filed on Jan. 18, 2008, entitled “Method and Apparatus for Transmitting a Packet Header in a Wireless Communication System,” all of which are hereby incorporated herein by reference.

### TECHNICAL FIELD

The present invention relates generally to a system and method for transmitting data, and more particularly to a system and method for dynamically creating or changing a bundle of service flows.

### BACKGROUND

Mobile worldwide interoperability for microwave access (WiMAX) offers scalability in both radio and network architecture. In one aspect of WiMAX's structure which offers such scalability, WiMAX uses the concept of a service flow (SF), which is a unidirectional flow of packets with a particular set of shared Quality of Service (QOS) parameters. Each SF is assigned a service flow identifier (SFID).

Under the 802.16e standard, these SFs may be dynamically changed or created. Currently, however, only one SF may be created or changed at a time. As such, each separate SF also requires a separate message (along with the overhead associated with each message) to be sent, even if the SFs have similar or identical QoS parameters. Such redundancy creates a repetition of messages and headers that generates much unnecessary overhead, thereby tying up bandwidth and generally reducing transmission speeds.

### SUMMARY OF THE INVENTION

These and other problems are generally solved or circumvented, and technical advantages are generally achieved, by preferred embodiments of the present invention which provide for a method of data transmission.

In accordance with a preferred embodiment of the present invention, a method for transmitting data comprises concatenating multiple parameters for a plurality of service flows into a single message. The message is then transmitted.

In accordance with another preferred embodiment of the present invention, a method for receiving data comprises receiving a single dynamic service message, the single dynamic service message comprising parameters associated with both a first service flow and a second service flow.

In accordance with yet another preferred embodiment of the present invention, a method for transmitting data comprises grouping a first set of parameters, the first set of parameters associated with multiple service flows. A second set of parameters is grouped, and the second set of parameters are associated with a single service flow. A single message with the first set of parameters and the second set of parameters is transmitted.

In accordance with yet another preferred embodiment of the present invention, a device for transmitting data, the device comprising a transmitter configured to provide multiple parameters for a plurality of service flows in a single message to a transmit antenna, and a transmit antenna to wirelessly transmit the single message.

In accordance with yet another preferred embodiment of the present invention, a device for receiving data, the device comprising a receive antenna to wirelessly receive a dynamic service message, and a receiver configured to receive the dynamic service message from the receive antenna, the dynamic service message comprising parameters associated with both a first service flow and a second service flow.

An advantage of a preferred embodiment of the present invention is the reduction or redundant messages and their associated overhead. This reduction leads to a decreased demand for bandwidth and, accordingly, faster transmission rates.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a wireless communications network in accordance with an embodiment of the present invention; and

FIG. 2 illustrates a base station and several mobile stations from a wireless communications network in accordance with an embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely data transmission utilizing service flows between a mobile station and a base station complying with the IEEE 802.16e standard, which is hereby incorporated herein by reference. The invention may also be applied, however, to other forms of data transmission.

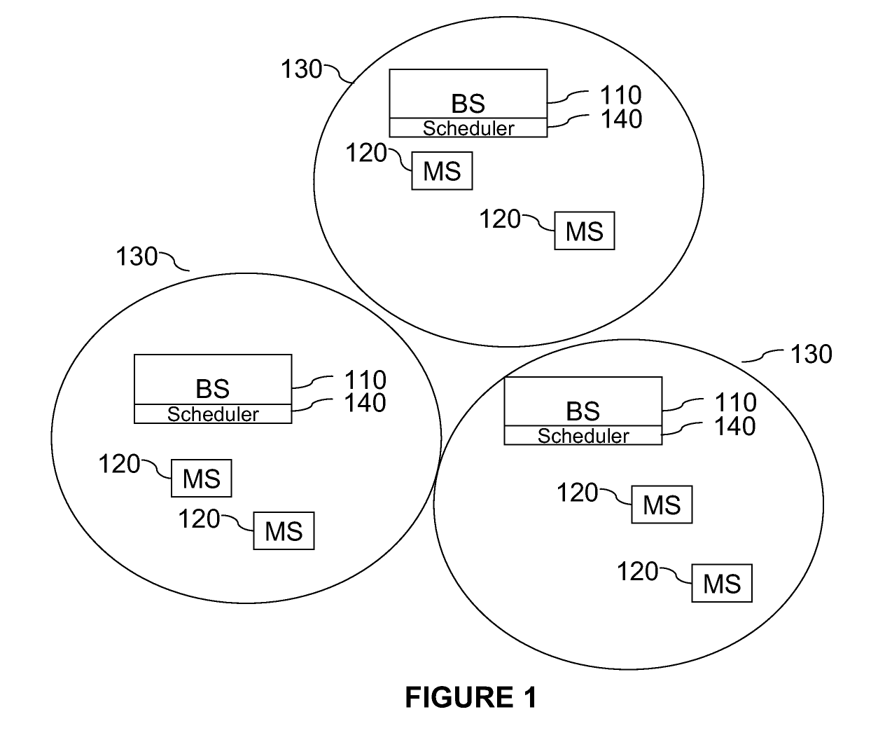

With reference now to FIG. 1, there is shown a wireless communications network which preferably comprises a plurality of base stations (BSs) 110 providing voice and/or data wireless communication service to a plurality of mobile stations (MSs) 120. The BSs 110, which may also be referred to by other names such as access network (AN), access point (AP), Node-B, etc., preferably downlink (DL) information to the MSs 120 while also receiving uplink (UL) information from the MSs 120.

Each BS 110 preferably has a corresponding coverage area 130. These coverage areas 130 represent the range of each BS 110 to adequately transmit data, and, while not necessarily shown in FIG. 1, the coverage areas 130 of adjacent BSs 110 preferably have some overlap in order to accommodate handoffs between BSs 110 whenever a MS 120 exits one coverage area 130 and enters an adjacent coverage area 130. Each BS 110 also preferably includes a scheduler 140 for allocating radio resources to the MSs 120.

Preferably, the wireless communications network includes, but is not limited to, an orthogonal frequency division multiple access (OFDMA) network such as an Evolved Universal Terrestrial Radio Access (E-UTRA) network, an Ultra Mobile Broadband (UMB) network, or an IEEE 802.16 network. However, as one of ordinary skill in the art will recognize, the listed networks are merely illustrative and are not meant to be exclusive. Any suitable multiple access scheme network, such as a frequency division multiplex access (FDMA) network wherein time-frequency resources are divided into frequency intervals over a certain time interval, a time division multiplex access (TDMA) network wherein time-frequency resources are divided into time intervals over a certain frequency interval, a code division multiplex access (CDMA) network wherein resources are divided into orthogonal or pseudo-orthogonal codes over a certain time-frequency interval, or the like may alternatively be used.

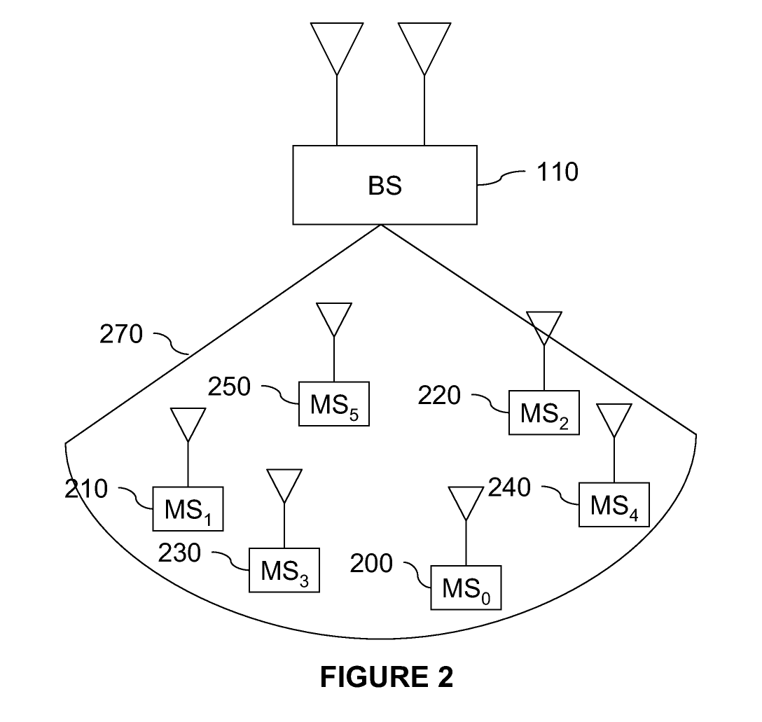

FIG. 2 illustrates one BS 110 and several MSs 120 from the wireless communications network of FIG. 1. As illustrated, the coverage area 130 shown in FIG. 1 is preferably divided into three reduced coverage areas 270, one of which is shown in FIG. 2. Six MSs 120 illustrated in FIG. 1 are individually shown in the reduced coverage area 270 as MS₀ 200, MS₁ 210, MS₂ 220, MS₃ 230, MS₄ 240, and MS₅ 250. The BS 110 typically assigns each of these MSs 120 one or more connection identifiers (CID) (or another similar identifier) to facilitate time-frequency resource assignments. The CID assignments are preferably transmitted from the BS 110 to MS₀ 200, MS₁ 210, MS₂ 220, MS₃ 230, MS₄ 240, and MS₅ 250 on a control channel, although the CID assignments can alternatively be permanently stored at the MSs 120, or else can be derived based on a parameter of either the MSs 120 or BS 110.

Under WiMAX the MSs 120 and the BSs 110 establish service flows (SFs) to assist in the regulation of communications between the MSs 120 and BSs 110. The SFs are unidirectional flows of packets with a particular set of shared Quality of Service (QoS) parameters, such as traffic priority, maximum sustained traffic rate, maximum burst rate, minimum tolerable rate, scheduling type, ARQ type, maximum delay, tolerated jitter, service data unit type and size, bandwidth request mechanism to be used, transmission PDU formation rules, or the like.

SFs may be created, changed, or deleted through a series of particular Medium Access Control (MAC) messages known collectively as Dynamic Service (DSx) messages. DSx messages include Dynamic Service Addition (DSA) messages, which are used to add or create a new SF, Dynamic Service Change (DSC) messages, which change an already existing SF, and Dynamic Service Deletion (DSD) messages, which delete an already existing SF. Each SF is assigned a service flow identification (SFID) by the BS 110.

In operation, in order to add a SF, the BS 110 may send a DSA Request (DSA-REQ) message to the MS 120. In response, the MS 120 sends a DSA Response (DSA-RSP) message confirming the addition of the SF. As another example, the BS 110 may send a DSC Request (DSC-REQ) to the MS 120 in order to change a SF, which then responds with a DSC Response (DSC-RSP) message to confirm the change of the SF.

In an embodiment of the present invention, a DSx Group Create/Change time/length/value (TLV) message may be included within any of the DSx messages, such as the DSA-REQ message, DSA-RSP message, DSC-REQ message, or DSC-RSP message. The DSx Group Create/Change TLV is preferably processed by the receiving station to create or change a bundle of multiple SFs using a single message instead of separate messages for each SF. As such, a single instance of the DSx Group Create/Change TLV may be used in any DSx message for all of the SFs. By creating or changing multiple SFs in a single message, the overhead associated with multiple messages may be reduced or eliminated, thereby reducing the amount of bandwidth used.

The DSx Group Create/Change TLV may be defined in the TLV mode as shown in Table 1:

TABLE 1

| Name | Type | Length | Value |
|---|---|---|---|
| DSx Group | 49 | variable | Compound |
| Create/ | | | |
| Change | | | |

As shown, the DSx Group Create/Change TLV has a variable length with compound values, as it is dependent at least in part upon the number of SFs and parameters involved. However, the DSx Group Create/Change TLV is preferably at least long enough to contain each of the SFIDs and their associated parameters, as further described below.

The DSx Group Create/Change TLV message preferably comprises two other TLV messages: the Common Parameters for DSx Group Create/Change TLV and the SFID Parameter List TLV. The Common Parameters for DSx Group Create/Change TLV is preferably a compound TLV value that encapsulates all of the SF parameter encodings that are common to all SFs specified in a particular DSx Group Create/Change TLV. The commonly related parameters may be all of or some subset of the parameters used to define SFs and may include any of the suitable QoS parameters, such as traffic priority, maximum sustained traffic rate, maximum burst rate, minimum tolerable rate, scheduling type, ARQ type, maximum delay, tolerated jitter, service data unit type and size, bandwidth request mechanism to be used, transmission PDU formation rules, or the like.

Preferably, only one instance of the Common Parameters for DSx Group Create/Change TLV is included within a particular DSx Group Create/Change TLV and is preferably located as the first attribute of the DSx Group Create/Change TLV. Furthermore, all of the rules and settings used to format the DSx message into which the Common Parameters for DSx Group Create/Change TLV is placed would also preferably be applicable to the parameters encapsulated within the Common Parameters for DSx Group Create/Change TLV.

The Common Parameters for DSx Group Create/Change TLV may be defined in the TLV mode as shown in Table 2:

TABLE 2

| Name | Type | Length | Value |
|---|---|---|---|
| Common | 49.1 | variable | Common Parameters for DSx Group |
| Parameters | | | Create/Change is a compound TLV |
| for DSx | | | value that encapsulates the common |
| Group | | | related service flow parameters |
| Create/ | | | encodings that are common to all |
| Change | | | service flows specified in this |
| | | | DSx Group Create/Change TLV. |
| | | | Common related service flow |
| | | | encodings shall be included in |
| | | | this TLV. |

The SFID Parameter List TLV is preferably a compound TLV value that encapsulates each SFID and its associated non-common parameters (because the common parameters are included within the Common Parameters for DSx Group Create/Change TLV). Similar to the Common Parameters for DSx Group Create/Change TLV, all of the rules and settings used to format the DSx message into which the SFID Parameter List TLV is placed would also preferably be applicable to the parameters encapsulated within the SFID Parameter List TLV.

The SFID Parameter List TLV, when included within the DSx Group Create/Change TLV, preferably is located as the last attribute within the DSx Group Create/Change TLV. Further, while the Common Parameters for DSx Group Create/Change TLV is preferably only included once in a DSx Group Create/Change TLV, the SFID Parameter List TLV may be included more than once, and is preferably included as many times as required in order to transmit all of the non-common SFID parameters associated with the multiple different SFs.

The SFID Parameter List TLV may be defined in the TLV mode as shown in Table 3:

TABLE 3

| Name | Type | Length | Value |
|---|---|---|---|
| SFID | 49.4 | variable | SFID Parameter List is a compound |
| Parameter | | | TLV value that encapsulates an |
| List | | | SFID and associated non-common |
| | | | parameters for that service flow, |
| | | | specified in this DSx Group |
| | | | Create/Change TLV. |

In order to transmit the non-common parameters, each SFID Parameter List TLV preferably includes at least two fields: the SFID field and the Non-Common Parameters for DSx Group Create/Change field. The SFID field preferably includes the SFID that has been assigned by the BS 110, and is preferably 4 bits in length. Alternatively, if the SFID is unassigned, the MS 120 preferably uses an SFID value of ‘0’, though each iteration of the SFID field in SFID Parameter List TLV preferably represents a separate and individual service flow.

The Non-Common Parameters for DSx Group Create/Change field preferably includes each of the non-common parameters specific to the individual SF associated with the SFID in the SFID field. As such, the Non-Common Parameters for DSx Group Create/Change field has a variable length, as these parameters include all of the parameters that were not included within the Common Parameters for DSx Group Create/Change TLV, thereby completing the transmission of the parameters for the multiple SFs. Furthermore, all of the rules and settings used to format the DSx message into which the Non-Common Parameters for DSx Group Create/Change field is placed would also preferably be applicable to the parameters encapsulated within the Non-Common Parameters for DSx Group Create/Change field.

However, the Common Parameters for DSx Group Create/Change TLV and the SFID Parameter List do not necessarily need to both be included in order to bundle multiple SFs into a single create/change message. As an example, if all SFs share common parameters, then only the Common Parameters for DSx Group Create/Change TLV need be included within the DSx Group Create/Change TLV, and the SFID Parameters List TLV may be excluded.

However, when the SFID Parameters List TLV and its associated SFIDs are excluded, an additional TLV is preferably included along with the Common Parameters for DSx Group Create/Change TLV in order to associate the common parameters with particular SFs. As such, an SFID List TLV is preferably included along with the Common Parameters for DSx Group Create/Change TLV. The SFID List TLV preferably includes a list of all of the SFIDs associated with the common parameters. However, the SFID List TLV is preferably excluded in a DSA-REQ message if the message is initiated by the MS 120 because the BS 110 assigns new SFIDs to the SFs.

The SFID List TLV may be defined in the TLV mode as shown in Table 4:

TABLE 4

| Name | Type | Length | Value |
|---|---|---|---|
| SFID List | 49.3 | n*4 | List of n SFIDs. |

Alternatively, if none of the SFs share a common parameter, then the Common Parameters for DSx Group Create/Change TLV may be excluded as there are no common parameters to be shared. As such, only the SFID Parameter List TLV, along with its associated SFID field and Non-Common Parameters for DSx Group Create/Change field, may be included within the DSx Group Create/Change TLV. In this embodiment, the SFID Parameter List TLV preferably includes a list of the SFIDs in the SFID field and their associated non-common parameters in the Non-Common Parameters for DSx Group Create/Change field.

From the above examples, it is apparent to one of ordinary skill in the art that any combination of common parameters and non-common parameters may be included within the present invention. These combinations also include the embodiments having no common parameters as well as embodiments having no non-common parameters. All of these embodiments are fully intended to be included within the scope of the present invention.

Additionally, while the above described embodiments have been described as a transmission from the BS 110 to the MS 120, the present invention may also be utilized for transmissions from the MS 120 to the BS 110. However, because the BS 110 assigns the SFIDs for the associated SFs during SF creation, the SFIDs are preferably set to 0 in the SFID Parameter List TLV included within the DSx Group Create/Change TLV as part of a DSA-REQ message sent by the MS 120. Once the DSA-REQ message has been received by the BS 110, the BS 110 preferably assigns the SFs their associated SFIDs and transmits them back to the MS 120. Additionally, the SFID List TLV may be excluded from the DSA-REQ message, but are preferably retained in other messages such as a DSA-RSP message from the BS 110, a DSC-REQ from the MS 120, or a DSC-RSP message from the BS 110 if all the SF's parameters are common.

In order to request SFIDs for the SFs that are desired to be created, a Qty SFID Request TLV is preferably included within the DSx Group Create/Change TLV. Preferably, the Qty SFID Request TLV is one byte in length and requests the quantity of desired service flows that the MS 120 is requesting. Additionally, the Qty SFID Request TLV is preferably sent by the MS 120 as the last attribute of the DSx Group Create/Change TLV in which it is located, and is preferably sent in a DSA-REQ.

The Qty SFID Request TLV may be defined in the TLV mode as shown in Table 4:

TABLE 4

| Name | Type | Length | Value |
|---|---|---|---|
| Qty SFID | 49.2 | 1 | Qty SFID request is the quantity of |
| request | | | service flows, of the same common |
| | | | parameter set configuration, |
| | | | that the MS is requesting. |

From the above described description, it is apparent that, by grouping the parameters of multiple SFs into the DSx Group Create/Change TLV, the multiple messages may be reduced down to a single message, thereby avoiding all of the extra overhead associated with the multiple messages. Accordingly, by reducing this overhead, less bandwidth is required, and transmission speeds may be increased.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the number of common parameters and the number of non-common parameters may be varied while remaining within the scope of the present invention.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for transmitting data, the method comprising:
concatenating multiple parameters for a plurality of service flows into a single message; and
wirelessly transmitting the single message.

2. The method of claim 1, wherein the concatenating multiple parameters further includes:
concatenating a first set of parameters that are common to a first service flow and a second service flow; and
concatenating a second set of parameters that are not common to the first service flow and the second service flow.

3. The method of claim 2, further comprising concatenating a first identifier associated with the first service flow and a second identifier associated with the second service flow.

4. The method of claim 1, wherein the multiple parameters are common to all of the plurality of service flows.

5. The method of claim 4, further comprising concatenating a list of identifiers associated with the multiple parameters, the list of identifiers indicating which service flows utilize the multiple parameters.

6. The method of claim 1, wherein the multiple parameters are not common to any of the service flows.

7. The method of claim 1, further comprising concatenating a request for a quantity of service flows into the single message.

8. The method of claim 1, further comprising concatenating a request for identifiers associated with the service flows with the multiple parameters.

9. A method for receiving data, the method comprising:
wirelessly receiving a single dynamic service message, the single dynamic service message comprising parameters associated with both a first service flow and a second service flow.

10. The method of claim 9, wherein the parameters associated with both the first service flow and the second service flow further comprise:
a first set of parameters, the first set of parameters being common parameters to both the first service flow and the second service flow; and
a second set of parameters, the second set of parameters associated with the first service flow but not the second service flow.

11. The method of claim 10, wherein the single dynamic service message further comprises a first identifier associated with the first service flow and a second identifier associated with the second service flow.

12. The method of claim 9, wherein the parameters associated with both the first service flow and the second service flow are all common to both the first service flow and the second service flow.

13. The method of claim 12, wherein the single dynamic service message further comprises a list of identifiers associated with the parameters, the list of identifiers indicating which service flows utilize the parameters.

14. The method of claim 9, wherein the parameters associated with both the first service flow and the second service flow are not common to both the first service flow and the second service flow.

15. The method of claim 9, wherein the single dynamic service message further comprises a request for a quantity of service flows into the single message.

16. A device for transmitting data, the device comprising:
a transmitter configured to provide multiple parameters for a plurality of service flows in a single message to a transmit antenna; and
a transmit antenna to wirelessly transmit the single message.

17. The device of claim 16, wherein the multiple parameters further include:
a first set of parameters that are common to a first service flow and a second service flow; and
a second set of parameters that are not common to the first service flow and the second service flow.

18. The device of claim 17, wherein the single message comprises a first identifier associated with the first service flow and a second identifier associated with the second service flow.

19. The device of claim 16, wherein the multiple parameters are common to all of the plurality of service flows.

20. The device of claim 19, wherein the single message comprises a list of identifiers associated with the multiple parameters, the list of identifiers indicating which service flows utilize the multiple parameters.

21. The device of claim 16, wherein the multiple parameters are not common to any of the service flows.

22. The device of claim 16, wherein the single message comprises a request for a quantity of service flows.

23. The device of claim 16, wherein the single message comprises a request for identifiers associated with the service flows with the multiple parameters.

24. A device for receiving data, the device comprising:
a receive antenna to wirelessly receive a dynamic service message; and
a receiver configured to receive the dynamic service message from the receive antenna, the dynamic service message comprising parameters associated with both a first service flow and a second service flow.

25. The device of claim 24, wherein the parameters associated with both the first service flow and the second service flow further comprise:
a first set of parameters, the first set of parameters being common parameters to both the first service flow and the second service flow; and
a second set of parameters, the second set of parameters associated with the first service flow but not the second service flow.

26. The device of claim 24, wherein the dynamic service message further comprises a first identifier associated with the first service flow and a second identifier associated with the second service flow.

27. The device of claim 24, wherein the parameters associated with both the first service flow and the second service flow are all common to both the first service flow and the second service flow.

28. The device of claim 27, wherein the dynamic service message further comprises a list of identifiers associated with the parameters, the list of identifiers indicating which service flows utilize the parameters.

29. The device of claim 24, wherein the parameters associated with both the first service flow and the second service flow are not common to both the first service flow and the second service flow.

30. The device of claim 24, wherein the dynamic service message further comprises a request for a quantity of service flows.
